(19) United States
(12) Patent Application Publication
(10) Pub. No.: US 2017/0321472 A1
(43) Pub. Date: Nov. 9, 2017

(54) SPACER FOR INSULATING GLAZING UNITS

(71) Applicant: SAINT-GOBAIN GLASS FRANCE, Courbevoie (FR)

(72) Inventors: Katrin FRANK, LEONBERG (DE); Walter SCHREIBER, AACHEN (DE); Hans-Werner KUSTER, AACHEN (DE)

(21) Appl. No.: 15/531,703

(22) PCT Filed: Dec. 1, 2015
(86) PCT No.: PCT/EP2015/078141

§ 371 Date: May 30, 2017

(30) Foreign Application Priority Data
Dec. 8, 2014 (EP) 14196689.5

(51) Int. Cl. E06B 3/663; E06B 3/673

(52) U.S. Cl. CPC E06B 3/66366; E06B 3/66352; E06B 3/67326; E06B 3/66314; E06B 3/66347; E06B 2003/66385

(57) ABSTRACT

A spacer for insulating glazing units with a polymeric main body composed of a first pane contact surface and a second pane contact surface running parallel thereto, a first glazing interior surface, a second glazing interior surface, an outer surface, a first hollow chamber, and a second hollow chamber, is realized with a groove to accommodate a pane runs parallel to the first pane contact surface and second pane contact surface between the first glazing interior surface and the second glazing interior surface, the first hollow chamber being adjacent the first glazing interior surface and the second hollow chamber being adjacent the second glazing interior surface, where the lateral flanks of the groove are formed by the walls of the first hollow chamber and the second hollow chamber, and a gas-permeable insert is contained in the groove or at least two inserts are mounted at a distance of at least 1 mm from one another.

The invention relates to a spacer for insulating glazing units, an insulating glazing unit, a method for production thereof, and use thereof.

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via external glazing. The increased costs necessary for heating and air-conditioning systems make up a part of the maintenance costs of the building that must not be underestimated. Moreover, as a consequence of more stringent construction regulations, lower carbon dioxide emissions are required. Triple insulating glazing units, without which, primarily as a result of increasingly rapidly rising prices of raw materials and more stringent environmental protection constraints, it is no longer possible to imagine the building construction sector are an important approach to a solution for this. Consequently, triple insulating glazing units constitute an increasingly larger part of the outward directed glazing units.

Triple insulating glazing units usually include three panes made of glass or polymeric materials that are separated from one another by two individual spacers. A further pane is placed on a double glazing unit using an additional spacer. During assembly of such a triple glazing unit, very small tolerance specifications apply since the two spacers must be installed at exactly the same height. Thus, compared to double glazing units, the assembly of triple glazing units is significantly more complex since either additional system components must be provided for the assembly of another pane or a time-consuming multiple pass through a conventional system is necessary

EP 0 852 280 A1 discloses a spacer for double insulating glazing units. The spacer includes a metal foil on the adhesion surface and a glass fiber content in the plastic of the main body. Such spacers are also frequently used in triple insulating glazing units, wherein a first spacer is mounted between a first outer pane and the inner pane and a second spacer is mounted between a second outer pane and the inner pane. Here, the two spacers must be installed congruently to ensure a visually appealing appearance.

WO 2010/115456 A1 discloses a hollow profile spacer with a plurality of hollow chambers for multiple glass panes comprising two outer panes and one or a plurality of middle panes that are installed in a groove-shaped accommodating profile. Here, the spacer can be manufactured from polymeric materials as well as being made of rigid materials, such as stainless steel or aluminum. The middle glass of the multiple glass panes is preferably fixed with a primary seal, in particular an adhesive based on butyl, acrylate, or hotmelt. By means of the fixing with the primary seal, an exchange of air between the interpane spaces of the multiple glass pane is prevented.

DE 10 2009 057 156 A1 describes a triple insulating glazing unit that includes a shear-resistant spacer that is bonded in a shear-resistant manner to two outer panes with a high-tensile adhesive. The spacer has a groove, in which the middle pane of the triple insulating glazing unit is fixed. The fixing is ensured, for example, by a butyl gasket in the groove. The two interpane spaces are hermetically sealed from one another.

The spacers described in WO 2010/115456 A1 and in DE 10 2009 057 156 A1, which can accommodate a third pane in a groove, have the advantage that only a single spacer has to be installed and, thus, the step of the alignment of two individual spacers in the prior art triple glazing unit is eliminated. Both documents describe the fixing of the middle pane using a seal such that an exchange of air between the inner interpane spaces is prevented and the two interpane spaces are hermetically sealed from one another. This has the disadvantage that no pressure equalization between the individual interpane spaces can occur. With temperature differences between the interpane space turned toward the building interior and the interpane space turned toward the building exterior, pressure differences arise between the two interpane spaces. When the interpane spaces are hermetically sealed, no equalization can occur, as a result of which there is a high load on the middle pane. In order to increase the stability of the middle pane, thicker and/or prestressed panes must be used. This results in increased material and production costs.

FR 2 253 138 discloses a sound attenuating apparatus for windows or doors with three glass plates arranged in parallel. This is a frame element that accommodates both the inner pane and the outer pane in a furrow/groove. Here, the outer panes are solidly fastened into the furrows, whereas the middle pane is freely supported. An exchange of air between the interpane spaces it is possible through gaps at the edge of the pane held in the frame element. Since the middle pane is freely supported, slippage of the middle pane in the groove/furrow is possible, which results in bothersome rattling noises during opening and closing of the window.

One object of the present invention is to provide an improved spacer for insulating glazing units, which enables tension-free fixing of a middle pane and simultaneous prevention of rattling noises during opening and closing of a window/a door, to provide an insulating glazing unit as well as an economical method for assembling an insulating glazing unit with a spacer according to the invention.

The object of the present invention is accomplished according to the invention by a spacer for insulating glazing units according to the independent claim 1. Preferred embodiments of the invention are apparent from the subclaims.

The spacer according to the invention for insulating glazing units comprises at least a polymeric main body, which has a first pane contact surface and a second pane contact surface running parallel thereto, a first glazing interior surface, a second glazing interior surface, and an outer surface. The polymeric main body has a wall thickness d. A first hollow chamber and a second hollow chamber as well as a groove are introduced into the polymeric main body. The groove runs parallel to the first pane contact surface and the second pane contact surface and serves to accommodate a pane. The first hollow chamber is adjacent the first glazing interior surface, while the second hollow chamber is adjacent the second glazing interior surface, with the glazing interior surfaces situated above the hollow chambers and the outer surface situated below the hollow chambers. In this context, “above” is defined as turned toward the pane interior of an insulating glazing unit with a spacer according to the invention, and “below” is defined as turned away from the pane interior. Since the groove runs between the first glazing interior surface and the second glazing interior surface, it laterally delimits the latter and separates the first hollow chamber and the second hollow chamber from one another. The lateral flanks of the groove are formed by the walls of the first hollow chamber and the second hollow chamber. The groove forms an indentation that is suitable to accommodate the middle pane (third pane) of an insulating glazing unit. Thus, the position of the third pane is fixed by two lateral flanks of the groove as well as the bottom surface of the groove. A gas-permeable insert or at least two inserts are mounted in the groove at a distance of at least 1 mm apart. Thus, in the finished insulating glazing unit, a gas exchange between the inner interpane spaces, which are adjacent the first and second glazing interior surfaces, is enabled.

The groove is wider than the pane mounted therein such that the insert can be inserted into the groove. The insert prevents slippage of the pane and a resultant development of noise during the opening and closing of the window. The insert is mounted, at least in one region of the lateral flanks of the groove, for example, as bulges in a subregion of the two lateral flanks. Preferably, the insert also extends over the bottom surface of the groove, by which means a rattling noise of the pane can be particularly effectively prevented. The insert furthermore compensates the thermal expansion of the third pane during heating, such that, independent of the climatic conditions, a tension-free fixing is ensured. Moreover, the use of an insert is advantageous with regard to minimization of the number of variants of the spacer. In order to keep the number of variants as low as possible and to nevertheless enable a variable thickness of the middle pane, one spacer can be used with different inserts. The variation of the insert is significantly more favorable in terms of production costs than the variation of the spacer.

In the context of the invention, a “gas-permeable embodiment of the insert” means that, in a insulating glazing unit, the first inner interpane space, which is between the first pane and the third pane, is connected to the second inner interpane space, which is between the third pane and the second pane, such that an exchange of gas or air is possible. Thus, pressure compensation between the inner interpane spaces is enabled, which, compared to an embodiment with hermetically sealed inner interpane spaces, results in a significant reduction of the load on the middle pane. This gas-permeable embodiment can be realized by the use of porous materials, such as polymeric foams, or, in the case of the use of gas type materials, by the introduction of connections, such as a channel or a plurality of channels, into the insert. Alternatively, the insert is not mounted continuously in the groove along the entire spacer profile, but, instead, inserts, into which the pane is fixed to prevent rattling of the pane in the groove, are mounted only in individual subsections. The distances between the inserts are at least 1 mm. in the regions remaining free of inserts, an air exchange and, hence, pressure equalization between adjacent inner interpane spaces can occur. Since the inserts are installed in sections, material costs can be saved compared to installation along the entire spacer profile.

Thus, the invention makes available a one-piece doubled spacer (“double spacer”) that enables a tension-free fixing of the middle pane. The load on the third pane is reduced since the spacer according to the invention enables pressure equalization between the inner interpane spaces. The two outer panes (first pane and second pane) are installed on the pane contact surfaces, whereas the middle pane (third pane) is inserted into the groove. Since the polymeric main body is formed as a hollow profile, the lateral flanks of the hollow chambers are flexible enough to yield at the time of insertion of the pane into the groove. The insert contained in the groove prevents slippage of the middle pane in the groove and an associated development of noise and, at the same time, provides for tension-free fixing of the pane. Since the insert is implemented gas-permeable or a plurality of inserts are installed at least 1 mm apart, a pressure equalization between the inner interpane spaces can occur in the finished insulating glazing unit. This results in a reduction in the load on the third pane with the use of the spacer according to the invention. Thus, thinner panes and, in particular, non-prestressed panes can be used.

Preferably, the bottom surface of the groove is directly adjacent the outer surface of the polymeric main body, without one or both hollow chambers extending below the groove. Thus, the greatest possible depth of the groove is obtained, with the surface of the lateral flanks maximized for stabilization of the pane.

The hollow chambers of the spacer according to the invention contribute not only to the flexibility of the lateral flanks but, furthermore, result in a weight reduction compared to a solidly formed spacer and can be available to accommodate other components, for example, a desiccant.

The first pane contact surface and the second pane contact surface represent the sides of the spacer onto which, at the time of incorporation of the spacer, the assembly of the outer panes (first pane and second pane) of an insulating glazing unit is done. The first pane contact surface and the second pane contact surface run parallel to one another.

The glazing interior surfaces are defined as the surfaces of the polymeric main body that face in the direction of the interior of the glazing unit after incorporation of the spacer in an insulating glazing unit. The first glazing interior surface is between the first and the third pane, whereas the second glazing interior surface is arranged between the third and the second pane.

The outer surface of the polymeric main body is the side opposite the glazing interior surfaces that points away from the interior of the insulating glazing unit in the direction of an outer insulating layer. The outer surface preferably runs perpendicular to the pane contact surfaces. Alternatively, the section of the outer surface nearest the pane contact surfaces can, however, be inclined at an angle of preferably 30° to 60° relative to the outer surface in the direction of the pane contact surfaces. This angled geometry improves the stability of the polymeric main body and enables better adhesive bonding of the spacer according to the invention with a barrier film. A planar outer surface that is perpendicular, in its entire course, to the pane contact surfaces has, in contrast, the advantage that the sealing surface between the spacer and the pane contact surfaces is maximized and simpler shaping makes the production process easier.

Preferably, the insert and the polymeric main body are made from different materials. A variation of the materials has the advantage that the insert can be made from flexible, elastic materials that can better compensate thermal expansion of a third pane and that can better prevent rattling of the pane in the groove than with production of the insert from the material of the polymeric main body.

Preferably, the insert is coextruded with the polymeric main body. This one-piece embodiment of a polymeric main body and insert is particularly stable and durable. Additionally, compared to the two-piece embodiment, one production step is saved, thus reducing production costs. Alternatively, it would also be conceivable to form the insert directly on the polymeric main body, for example, by producing both components together in a two-component injection molding process.

In an alternative preferred embodiment, the insert is slid or inserted into the groove. In this case, the polymeric main body is manufactured separately, and prior to the assembly of the insulating glazing unit, the prefabricated insert is slid or inserted into the groove. Profiles suitable as inserts can be manufactured separately by extrusion. Alternatively, sealing strips or sealing profiles can be purchased ready-made as rolled goods. The two-piece embodiment of the insert and the main body enables a particularly flexible adaptation of the manufacturer of insulating glazing units, since in the case of different pane thicknesses of the middle glass, the same polymeric main body can be used and only the insert has to be varied.

In another advantageous embodiment, the insert is injected into the groove of the previously manufactured polymeric main body. This process can be particularly readily automated. Injection in conjunction with the non-continuous embodiment of the insert is particularly advantageous since the insert can very easily be injected only into individual sections.

Preferably, the insert includes a butyl sealant. Butyl sealants are widely used in the production of insulating glazing units to ensure the bonding of spacers and panes. These sealants are, consequently, tested and suitable for use in insulating glazing units. Butyl can be used in the form of prefabricated strings or, after heating, injected at the designated points in the groove. Particularly good results are obtained with butyl sealants.

Preferably, the insert includes a thermoplastic elastomer, preferably a urethane-based thermoplastic elastomer (TPU). Thermoplastic elastomers are particularly advantageous due to their good processability. The elastomers used must not contain any materials that escape into the pane Interior during its service life and thus result in the formation of condensation. Particularly good results are obtained with urethane-based thermoplastic elastomers.

Preferably, the insert includes a silicone sealant. The silicone sealant can be injected or used as a prefabricated profile. Good results are obtained with silicone sealants.

In an alternative advantageous embodiment, the insert includes an ethylene-propylene diene rubber (EPDM). Particularly good results are obtained with this material.

In a preferred embodiment, a gas- and vapor-tight barrier is applied on the outer surface of the polymeric main body and at least a part of the pane contact surfaces. The gas- and vapor-tight barrier improves the tightness of the spacer against gas loss and penetration of moisture. Preferably, the barrier is applied to roughly one half to two thirds of the pane contact surfaces, In the finished insulating glazing unit, the barrier is in contact with the material of the outer seal and is thus protected against damage.

In a preferred embodiment, the gas- and vapor-tight barrier is implemented as a film. This barrier film includes at least one polymeric layer as well as one metallic layer or one ceramic layer. The layer thickness of the polymeric layer is between 5 μm and 80 μm, whereas metallic layers and/or ceramic layers with a thickness of 10 nm to 200 nm are used. Within the layer thicknesses mentioned, particularly good tightness of the barrier film is obtained. The barrier film can be applied on the polymeric main body, for example, glued. Alternatively, the film can be coextruded together with the main body.

Particularly preferably, the barrier film includes at least two metallic layers and/or ceramic layers, which are arranged alternatingly with at least one polymeric layer. Preferably, the outward lying layers are formed by the polymeric layer. The alternating layers of the barrier film can be bonded to one another or applied on one another in various methods known in the prior art. Methods for depositing metallic or ceramic layers are well known to the person skilled in the art. The use of a barrier film with an alternating layer sequence is particularly advantageous with regard to the tightness of the system. A defect in one of the layers does not result in a loss of function of the barrier film. By comparison, in the case of a single layer, one small defect can already result in a complete failure. Furthermore, the application of multiple thin layers is advantageous compared to a thick layer since with increasing layer thicknesses, the risk of internal adhesion problems increases. Also, thicker layers have higher conductivity such that such a film is less suitable thermodynamically.

The polymeric layer of the film preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably includes iron, aluminum, silver, copper, gold, chromium, and/or alloys or oxides thereof. The ceramic layer of the film preferably includes silicon oxides and/or silicon nitrides.

In an alternative preferred embodiment, the gas- and vapor-tight barrier is preferably implemented as a coating. The coating includes aluminum, aluminum oxides, and/or silicon oxides and is preferably applied by a PVD method (physical vapor deposition). By this means, the production method can be significantly simplified since the polymeric main body is provided, for example, by extrusion, with the barrier coating directly after production and no separate step is necessary for the application of a film. The coating including aluminum, aluminum oxides, and/or silicon oxides delivers particularly good results in terms of tightness and, in addition, presents excellent adhesion properties relative to the outer seal materials used in insulating glazing units.

In a preferred embodiment, a web is mounted on the side of the spacer according to the invention opposite the groove. The web is preferably situated directly below the groove. The web serves to support the spacer frame with an integrated third pane during the insulating glazing unit production after the bonding of the first and second pane to the pane contact surfaces. Thus, sliding off of the spacer frame before and after pressing or during curing of the outer seal is prevented. With the use of a spacer with a web, sagging of the spacer frame with an integrated middle glass during insulating glazing unit production, as would happen with comparable spacers without a web, is impossible. In addition, the web improves the thermal insulating properties of the edge bond of an insulating glazing unit. Since the material of the web has lower thermal conductivity than the outer seal, thermal separation occurs by means of the web. The spacer is inserted such that the edge of the web is situated at the same height with the edges of the two panes and, hence, is arranged flush with them. The web of the spacer thus divides the outer interpane space into two outer interpane spaces, a first outer interpane space and a second outer interpane space. The outer interpane space is defined as the space that is delimited by the first pane, the second pane, and the outer surface of the spacer. Since the entire outer interpane space between the outer panes is divided by the web of the spacer according to the invention into two narrower interpane spaces, the filling with the material of the outer seal can be performed on a standard system for triple insulating glazing units. These systems usually use two nozzles, which are in each case guided along between an outer pane and the adjacent middle pane, with the two pane edges serving as a guide. Here, the web of the spacer assumes the function of the middle pane and serves as a guide for the nozzles for filling the outer interpane spaces with the material of the outer seal.

The “edge of the web” refers to the lower surface of the web, which faces away from the pane interior and, after incorporation into an insulating glazing unit, faces toward the external environment. The “lateral surfaces of the web” are the surfaces of the web which, after incorporation of the spacer into an insulating glazing unit, face toward the first pane and toward the second pane and run parallel thereto. In the finished insulating glazing unit, the lateral surfaces are in contact with the outer seal. The lateral surfaces of the web can run parallel to the first pane and the second pane as well as being inclined in one direction or another. The height b of the web defines the dimensions of the outer interpane space of the finished insulating glazing unit, since its edge is situated at the same height as the edges of the outer panes. The height b is preferably between 2 mm and 8 mm. The width a of the web preferably matches the width of the groove on the bottom surface, since, thus, particularly good stabilization of the spacer frame is obtained. The width a of the web is preferably between 1 mm and 10 mm, particularly preferably between 2 mm and 5 mm. The web preferably includes polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Optionally, the web can also be glass fiber reinforced. Particularly preferably, the web is made of the same material as the material of the polymeric main body so that the web and the polymeric main body have the same coefficient of linear expansion. This contributes to improved stability of the spacer.

The polymeric main body preferably includes polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Particularly good results are obtained with these materials.

Preferably, the polymeric main body is glass fiber reinforced. The coefficient of thermal expansion of the main body can be varied and adapted by the selection of the glass fiber content in the main body. By adaptation of the coefficient of thermal expansion of the polymeric main body and of the barrier film or barrier coating, temperature-related stresses between the different materials and flaking of the barrier film or barrier coating can be avoided. The main body preferably has a glass fiber content of 20% to 50%, particularly preferably of 30% to 40%. At the same time, the glass fiber content in the polymeric main body improves strength and stability.

The polymeric main body preferably has, along the glazing interior surfaces, a total width of 10 mm to 50 mm, particularly preferably of 20 mm to 36 mm. The distance between the first and the third pane or between the third pane and the second pane is determined by the selection of the width of the glazing interior surfaces. Preferably, the widths of the first glazing interior surface and of the second glazing interior surface are the same. Alternatively, asymmetric spacers are also possible, whereby the two glazing interior surfaces have different widths. The exact dimensions of the glazing interior surfaces are governed by the dimensions of the insulating glazing unit and the desired sizes of the interpane space.

The polymeric main body preferably has, along the pane contact surfaces, a height of 5 mm to 15 mm, particularly preferably of 5 mm to 10 mm.

The groove preferably has a depth of 1 mm to 15 mm, particularly preferably of 2 mm to 4 mm. With this, stable fixing of the third pane can be achieved.

The wall thickness d of the polymeric main body is 0.5 mm to 15 mm, preferably 0.5 mm to 10 mm, particularly preferably 0.7 mm to 1 mm.

The polymeric main body preferably includes a desiccant, preferably silica gels, molecular sieves, CaCl₂, Na₂SO₄, activated carbon, silicates, bentonites, zeolites, and/or mixtures thereof. The desiccant is preferably incorporated into the main body. Particularly preferably, the desiccant is situated in the first and second hollow chambers of the main body.

In a preferred embodiment, the first glazing interior surface and/or the second glazing interior surface has at least one opening. Preferably, a plurality of openings are made in both glazing interior surfaces. The total number of openings depends on the size of the insulating glazing unit. The openings connect the hollow chambers to the interpane spaces, making a gas exchange between them possible. Thus, absorption of atmospheric moisture by a desiccant situated in the hollow chambers is permitted and, and, fogging of the panes is prevented. The openings are preferably implemented as slits, particularly preferably as slits with a width of 0.2 mm and a length of 2 mm. The slits ensure optimum air exchange without the desiccant being able to penetrate out of the hollow chambers into the interpane spaces.

The lateral flanks of the groove can run parallel to the pane contact surfaces as well as being inclined in one direction or another. By inclining the lateral flanks in the direction of the third pane, a taper is produced that can serve to precisely fix the third pane. In addition, the visual impression when looking in the direction of the glazing interior surfaces can be improved since, by means of the taper, an insert accommodated in the lower region of the groove can be concealed.

The invention further includes an insulating glazing unit with at least a first pane, a second pane and a third pane and a spacer according to the invention arranged circumferentially between the first and the second pane. The first pane contacts the first pane contact surface of the spacer, while the second pane contacts the second pane contact surface. The third pane is inserted into the groove of the spacer. A plastic sealing compound, for example, is used as the outer seal.

The first pane and the second pane preferably protrude beyond the first pane contact surface and the second pane contact surface such that an outer interpane space is created, which is filled with the outer seal. The outer seal increases the mechanical stability of the insulating glazing unit. The outer interpane space is defined as the space that is delimited by the first pane, the second pane, and the outer surface of the spacer.

Preferably, the outer seal includes polymers or silane-modified polymers, particularly preferably organic polysulfides, silicones, room-temperature vulcanizing (RTV) silicone rubber, peroxide vulcanizing silicone rubber, and/or addition vulcanizing silicone rubber, polyurethanes, and/or butyl rubber.

At the corners of the insulating glazing unit, the spacers are preferably linked to one another via corner connectors. Such corner connectors can be implemented, for example, as a molded plastic part with a seal, in which two spacers provided with a miter cut abut. In principle, various geometries of the insulating glazing unit are possible, for example, rectangular, trapezoidal, and rounded shapes. To produce round geometries, the spacer according to the invention can be bent, for example, in the heated state.

The panes of the insulating glazing unit are connected to the spacer via a seal. For this, a seal is mounted between the first pane and the first pane contact surface and/or the second pane and the second pane contact surface. The seal includes a polyisobutylene. The polyisobutylene can be a cross-linking or a non-cross-linking polyisobutylene.

The first pane, the second pane, and/or the third pane of the insulating glazing unit preferably include glass and/or polymers, particularly preferably quartz glass, borosilicate glass, soda lime glass, polymethylmethacrylate, and/or mixtures thereof.

The first pane and the second pane have a thickness of 2 mm to 50 mm, preferably 3 mm to 16 mm, with the two panes also possibly having different thicknesses. The third pane as a thickness of 1 mm to 4 mm, preferably of 1 mm to 3 mm, and particularly preferably of 1.5 mm to 3 mm. The spacer according to the invention enables, by means of the tension-free fixing, an advantageous reduction of the thickness of the third pane while maintaining stability of the glazing unit. Preferably, the thickness of the third pane is less than the thicknesses of the first and second pane. In a possible embodiment, the thickness of the first pane is 3 mm, the thickness of the second pane is 4 mm, and the thickness of the third pane is 2 mm. Such an asymmetric combination of the pane thicknesses results in a significant improvement of the acoustic damping.

The insulating glazing unit is filled with a protective gas, preferably with a noble gas, preferably, argon or krypton, which reduce the heat transfer value in the insulating glazing unit interspace.

The third pane of the insulating glazing unit preferably has a low-E coating. With low-E coatings, the thermal insulation capacity of the insulating glazing unit can be increased even more and improved. These coatings are thermal radiation reflecting coatings that reflect a significant portion of the infrared radiation which, in summer, results in reduced warming of the living space. Various low-E coatings are known, for example, from DE 10 2009 006 062 A1, WO 2007/101964 A1, EP 0 912 455 B1, DE 199 27 683 C1, EP 1 218 307 B1, and EP 1 917 222 B1.

The third pane of the insulating glazing unit is preferably not prestressed. By eliminating the prestressing process, the production costs can be reduced. Furthermore, the pane is fixed in the groove with flexible lateral flanks and insert and not by adhesive bonding. Since pressure equalization between the inner interpane spaces is possible in an insulating glazing unit according to the invention, the load on the third pane is significantly less than with hermetically sealed inner interpane spaces. Thus, the spacer according to the invention enables the production of a triple glazing unit with a low-E coating on the third pane, without prestressing of the third pane being necessary. With adhesive bonding or with an otherwise rigid locking of the pane, the heating of the pane caused by the low-E coating would favor a failure of the adhesive bond. Furthermore, prestressing of the third pane would be necessary to compensate for arising stresses. However, with the use of the spacer according to the invention, the prestressing process is eliminated, by which means a further cost reduction can be achieved. By means of the tension-free fixing in the groove with an insert, the thickness and, hence, the weight of the third pane can also be advantageously reduced.

In another embodiment, the insulating glazing unit comprises more than three panes. In this case, the spacer can include multiple grooves that can accommodate further panes.

A plurality of panes could also be implemented as composite glass panes.

The invention further includes a method for producing an insulating glazing unit according to the invention comprising the steps:
a) Providing a polymeric main body with an insert,
b) Insertion of the third pane into the groove of the spacer,
c) Mounting the first pane on the first pane contact surface of the spacer,
d) Mounting the second pane on the second pane contact surface of the spacer, and
e) Pressing the pane arrangement.

First, a polymeric main body with an insert is provided. Then, the third pane can be inserted into the groove. In contrast to a method in which the insert is first applied on the pane and, then, the prepared pane is inserted into the groove, in the method according to the invention, the preparation of the third pane with the insert is eliminated. Consequently, in accordance with the method according to the invention, the preparation of the third pane can be done as with the use of a spacer without an insert. After insertion of the third pane into the groove of the spacer, this preassembled component can be processed in a conventional double glazing system known to the person skilled in the art. The costly Installation of additional system components or a loss of time with multiple passes of the system as with the use of multiple spacers can thus be avoided. This is particularly advantageous with regard to productivity gains and cost reduction. Furthermore, even with the use of low-E or other functional coatings on the third pane in accordance with the method according to the invention, no prestressing of the third pane is necessary since the spacer with the insert according to the invention fixes the pane tension-free in its circumference.

In a preferred embodiment of the method, the spacer is first preshaped to form a rectangle open on one side. Here, for example, three spacers can be provided with a miter cut and linked at the corners by corner connectors. Instead of this, the spacers can also be directly welded to one another, for example, by ultrasonic welding. The third pane is slid into the groove of the spacer starting from the open side of the arrangement into the spacer arranged U-shaped. The remaining open edge of the third pane is then also closed with a spacer. Optionally, before the assembly of the spacer, an insert can be applied on the pane edge. Thereafter, the processing of the preassembled component is done in accordance with the method according to the invention, wherein, in the next step, the first pane is mounted on the first pane contact surface.

Preferably, the interpane spaces between the first pane and the third pane as well as between the second pane and the third pane are filled with a protective gas before the pressing of the pane arrangement.

Preferably, the outer interpane spaces are filled with an outer seal. The outer seal serves for the mechanical stabilization of the insulating glazing unit.

The invention further includes the use of a spacer according to the invention in multiple glazing units, preferably in insulating glazing units, particularly preferably in triple insulating glazing units.

The invention is explained in detail in the following with reference to drawings. The drawings are purely schematic representations and are not true to scale. They in no way restrict the invention. They depict:

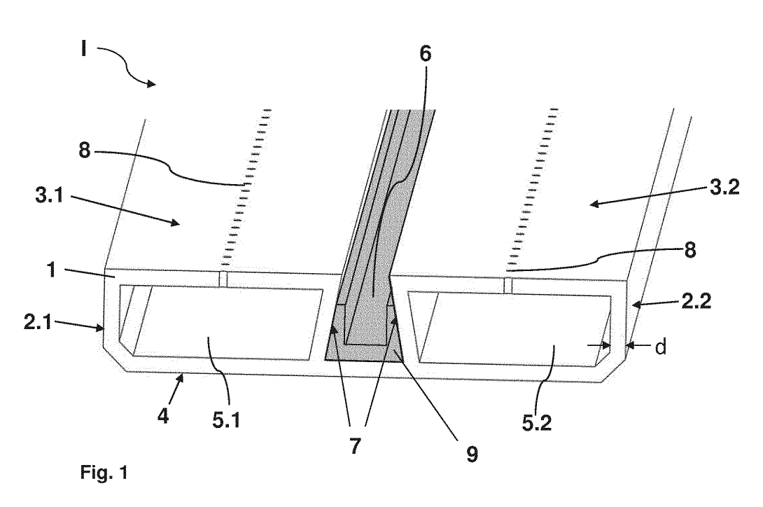

FIG. 1 a possible embodiment of the spacer according to the invention,

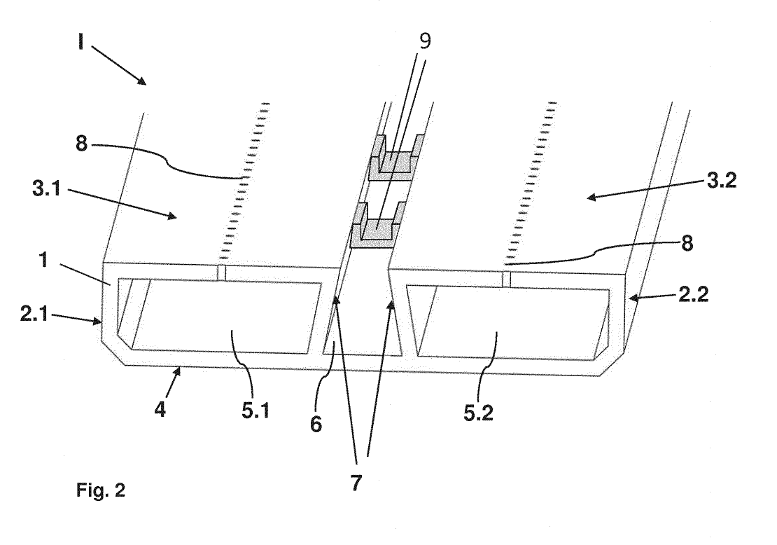

FIG. 2 another possible embodiment of the spacer according to the invention,

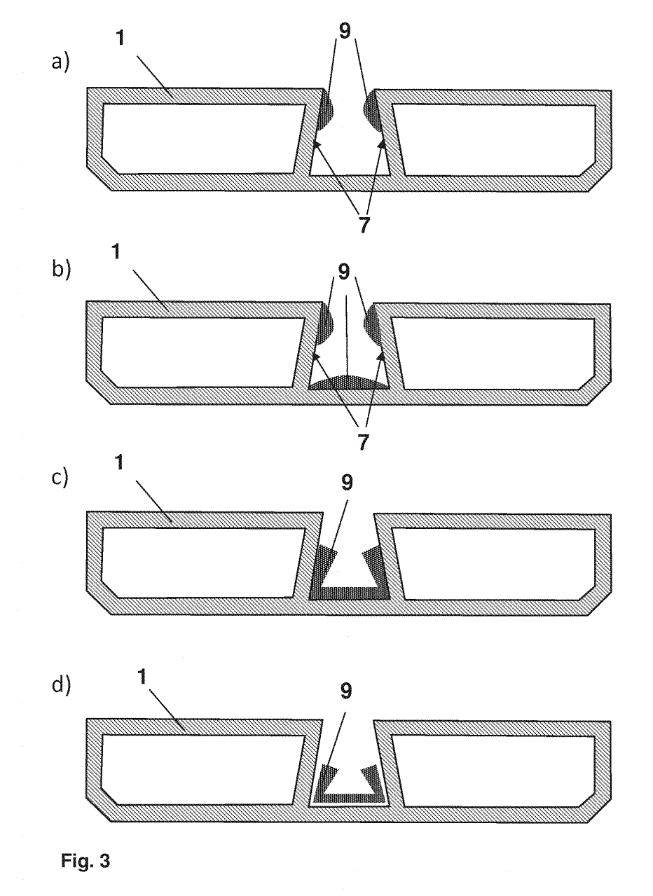

FIG. 3 several cross-sections through possible embodiments of spacers according to the invention,

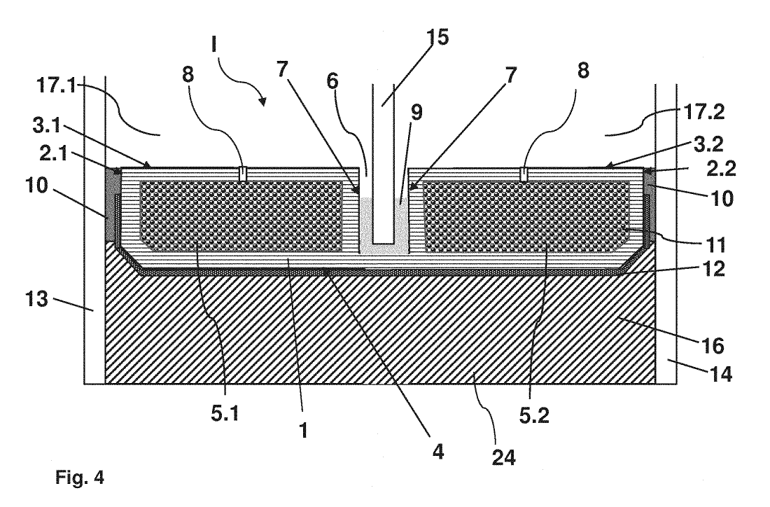

FIG. 4 a cross-section of a possible embodiment of the insulating glazing unit according to the invention,

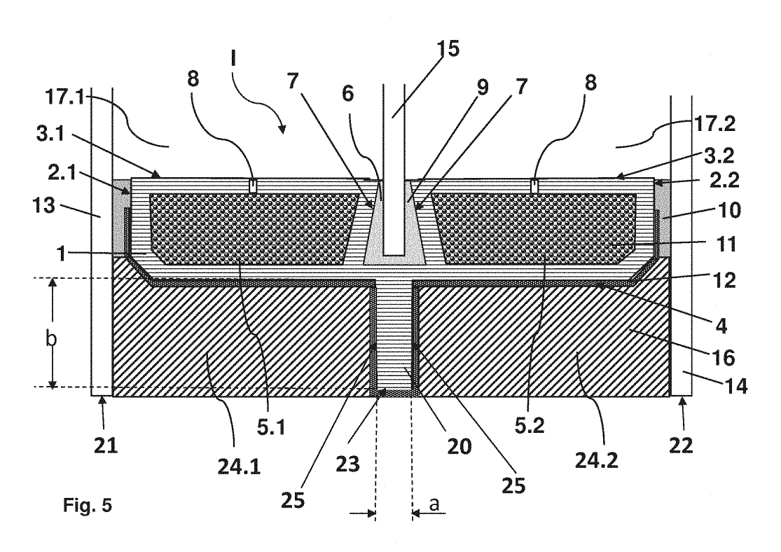

FIG. 5 a cross-section of another possible embodiment of the insulating glazing unit according to the invention, and

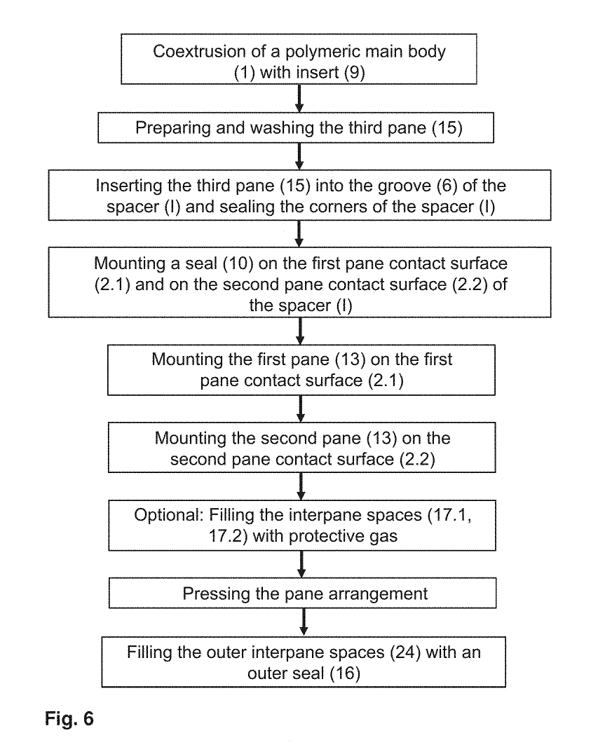

FIG. 6 a flowchart of a possible embodiment of the method according to the invention.

FIG. 1 depicts a cross-section of the spacer 1 according to the invention. The glass fiber reinforced polymeric main body 1 comprises a first pane contact surface 2.1, a second pane contact surface 2.2 running parallel thereto, a first glazing interior surface 3.1, a second glazing interior surface 3.2, and an outer surface 4. A first hollow chamber 5.1 is situated between the outer surface 4 and the first glazing interior surface 3.1, while a second hollow chamber 5.2 is arranged between the outer surface 4 and the second glazing interior surface 3.2. A groove 6, which runs parallel to the pane contact surfaces 2.1 and 2.2, is situated between the two hollow chambers 5.1 and 5.2. The lateral flanks 7 of the groove 6 are formed by the walls of the two hollow chambers 5.1 and 5.2, while the bottom surface of the groove 6 is adjacent the web. The lateral flanks 7 of the groove 6 are inclined inward in the direction of a pane to be accommodated in the groove 6. Thus, a tapering of the groove 6 is created at the level of the glazing interior surfaces 3.1 and 3.2, which tapering favors the fixing of a pane in the groove 6, and, at the same time, conceals the insert contained in the groove 6. An insert 9 that is installed along the entire spacer profile is introduced into the groove 6. The insert 9 fixes the panes to be inserted in the groove 6 and prevents development of noise during opening and closing of the window and compensates heat-induced thermal expansion of the pane to be inserted. The insert 9 covers the bottom surface of the groove 6 and a portion of the lateral lateral flanks 7 of the groove. The insert 9 is produced from a porous polyurethane foam and is coextruded with the polymeric main body. The use of the porous polyurethane foam ensures the connection of the inner interpane spaces in the finished insulating glazing unit. The wall thickness d of the polymeric main body is 1 mm. The outer surface 4 runs largely perpendicular to the pane contact surfaces 2.1 and 2.2 and parallel to the glazing interior surfaces 3.1 and 3.2. The sections of the outer surface 4 nearest the pane contact surfaces 2.1 and 2.2 are, however, inclined at an angle of preferably 30° to 60° relative to the outer surface 4 in the direction of the pane contact surfaces 2.1 and 2.2. This angled geometry improves the stability of the polymeric main body 1 and enables better adhesion of the spacer I according to the invention to a barrier film. The polymeric main body 1 contains styrene acrylonitrile (SAN) with roughly 35 wt.-% glass fiber. The glazing interior surfaces 3.1 and 3.2 have, at regular intervals, openings 8, which connect the hollow chambers 5.1 and 5.2 to the air space above the glazing interior surfaces 3.1 and 3.2. The spacer I has a height of 6.5 and a total width of 34 mm. The first glazing interior surface 3.1 is 16 mm wide and the second glazing interior surface 3.2 is 16 mm wide. The total width of the spacer I is the sum of the widths of the glazing interior surfaces 3.1 and 3.2 and the thickness of the third pane 15 with insert 9 to be inserted into the groove 6.

FIG. 2 depicts a cross-section of the spacer l according to the invention. The spacer depicted essentially corresponds to that depicted in FIG. 1. A plurality of inserts 9 made of EPDM are mounted in the groove 6. The inserts fix the third pane 15 without tension and, at the same time, prevent development of noise from slippage in the groove 6. The inserts 9 rest against the lateral flanks 7 and cover the bottom surface of the groove 6. The distance between the inserts 9 is roughly 2 cm. In the exposed section, pressure compensation between adjacent inner interpane spaces 17.1 and 17.2 is possible after installation of a third pane 15 to be inserted.

FIG. 3 depicts several cross-sections through possible embodiments of spacers according to the invention. The polymeric main body 1 is implemented as in FIG. 1. Different profiles of the insert 9 are depicted in the detail figures a) to d). In FIG. 3a), the insert 9 is installed as two bulges on the lateral flanks 7. The insert 9 does not cover the bottom surface of the groove. Thus, the middle pane to be inserted is stabilized on the sides and rattling in the groove 6 is prevented. With this solution, material is saved on the bottom surface.

In FIG. 3b), in addition to the bulges on the lateral flanks 7 depicted in FIG. 3a), an insert 9 is installed on the bottom surface. Thus, the third pane is additionally stabilized and squeaking or rattling is even better prevented. The variants depicted in FIGS. 3a) and 3b) can, for example, be produced by coextrusion of the insert and the polymeric main body.

FIG. 3c) depicts an insert that covers the bottom surface of the groove and the adjacent region of the lateral flanks 7 of the groove. This shape of the insert 9 is particularly easy to manufacture since it comprises one piece. The insert 9 depicted in FIG. 3c) fits flush into the groove 6. The dimensions of the insert 9 depicted in FIG. 3d) are somewhat smaller than those of the groove 6. This embodiment is particularly suitable to be slid into the previously manufactured polymeric main body 1. After insertion of the middle pane 15, a stable tension-free fixing is achieved.

FIG. 4 depicts a cross-section of an insulating glazing unit according to the invention with a spacer I according to the invention. The interspace between the first pane 13 and the third pane 15 delimited by the first glazing interior surface 3.1 is defined here as the first inner interpane space 17.1 and the space between the third pane 15 and the second pane 14 delimited by the second glazing interior surface 3.2 is defined as the second inner interpane space 17.2. Via the openings 8 in the glazing interior surfaces 3.1 and 3.2, the inner interpane spaces 17.1 and 17.2 are connected to the respective underlying hollow chamber 5.1 or 5.2. A desiccant 11 made of a molecular sieve is situated in the hollow chambers 5.1 and 5.2. Through the openings 8, a gas exchange occurs between the hollow chambers 5.1, 5.2 and the interpane spaces 17.1, 17.2, wherein the desiccant 11 extracts the atmospheric humidity from the interpane spaces 17.1 and 17.2. Here, the first pane 13 of the triple insulating glazing unit is connected by a seal 10 to the first pane contact surface 2.1 of the spacer I, while the second pane 14 is connected by a seal 10 to the second pane contact surface 2.2. The seal 10 is made of a cross-linking polyisobutylene. A third pane 15 is inserted into the groove 6 of the spacer via an insert 9. The insert 9 encloses the edge of the third pane 15 and fits flush into the groove 6. The insert 9 is made of butyl rubber. The insert 9 fixes the third pane 15 tension-free and compensates thermal expansion of the pane. Furthermore, the insert 9 prevents the development of noise from slippage of the third pane 15. In order that a gas exchange and, hence, a pressure equalization between the two inner interpane spaces 17.1, 17.2 can occur, a plurality of inserts 9 with spaces between them are introduced into the groove 6, as depicted in FIG. 2. The lateral flanks 7 of the groove 6 run, in this case, parallel to the pane contact surfaces 2.1 and 2.2. The insert 9 extends over the entire width of the bottom surface but only partially covers the lateral flanks 7 of the groove 6, by which means material is saved. The polymeric main body 1 is made of styrene acrylonitrile (SAN) with roughly 35% glass fiber. A barrier 12 that reduces the thermal transfer through the polymeric main body 1 into the interpane spaces 17 is applied on the outer surface 4 and a part of the pane contact surfaces 2.1, 2.2. The barrier 12 is implemented as a barrier film 12 and can, for example, be fastened with a polyurethane hot melt adhesive on the polymeric main body 1. The barrier film 12 comprises four polymeric layers of polyethylene terephthalate with a thickness of 12 μm and three metallic layers made of aluminum with a thickness of 50 nm. The metallic layers and the polymeric layers are alternatingly applied in each case, with the two outer layers being formed by polymeric layers. The first pane 13 and the second pane 14 protrude beyond the pane contact surfaces 2.1 and 2.2 such that an outer interpane space 24, which is filled with an outer seal 16, is created. The first pane 13 and the second pane 14 are made of soda lime glass with a thickness of 3 mm, while the third pane 15 is formed from soda lime glass with a thickness of 2 mm.

FIG. 5 depicts a cross-section of another insulating glazing unit according to the invention with a spacer I according to the invention. The insulating glazing unit essentially corresponds to the insulating glazing unit depicted in FIG. 4. The lateral flanks 7 of the groove 6 are inclined inward in the direction of the third pane 15. A web 20 is installed below the groove 6. The web 20 serves, among other things, for stabilization of the spacer with an integrated third pane during the production of the insulating glazing unit. The height b of the web is 4.5 and the width a of the web is 3 mm. The polymeric main body 1 and the web 20 are implemented in one piece. Thus, a particularly stable connection between the web 20 and the polymeric main body 1 is created. The web 20 divides the outer interpane space into a first outer interpane space 24.1 and a second outer interpane space 24.2. The edge of the first pane 21, the edge of the second pane 22, and the edge of the web 23 are arranged at one height. The outer interpane spaces 24.1 and 24.2 are filled with an organic polysulfide 16. The web 20 divides the outer seal 16 into two parts. Since the thermal conductivity of the outer seal 16 is higher than that of the web 20, a thermal decoupling occurs, resulting in an improvement of the thermal insulating properties of the edge bond. A gas- and vapor-tight barrier 12 is applied on the outer surface 4, which, in this one-piece embodiment of the main body 1 and the web 20, also includes the side surfaces 25 and the edge 23 of the web.

FIG. 6 depicts a flowchart of a possible embodiment of the method according to the invention. First, the polymeric main body 1 with the insert 9 is coextruded. Then, the third pane 15 is prepared and washed. The third pane 15 is now slid into the groove 6 of the spacer I according to the invention. Here, three spacers I can, for example, be preshaped to form a rectangle open on one side, wherein the third pane 15 is slid into the groove 6 via the open side. Then, the fourth pane edge is closed with a spacer I. The corners of the spacer are either welded or linked to one another via corner connectors. These first three process steps serve to prepare a pane 15 with a spacer I according to the invention. Such a preassembled component can then be further processed in a conventional double glazing system. The assembly of the first pane 13 and the second pane 14 on the pane contact surfaces 2.1 and 2.2 via a seal 10 in each case is done in the double glazing system. Optionally, a protective gas can be introduced into the interpane spaces 17.1 and 17.2. Then, the insulating glazing unit is pressed. In the last step, an outer seal 16 is filled into the outer interpane spaces 24.1 and 24.2, and the finished insulating glazing unit is placed on a rack to dry.

### LIST OF REFERENCE CHARACTERS

I spacer
1 polymeric main body
2 pane contact surfaces
2.1 first pane contact surface
2.2 second pane contact surface
3 glazing interior surfaces
3.1 first glazing interior surface
3.2 second glazing interior surface
4 outer surface
5 hollow chambers
5.1 first hollow chamber
5.2 second hollow chamber
6 groove
7 lateral flanks
8 openings
9 insert
10 seal
11 desiccant
12 barrier/barrier film/barrier coating
13 first pane
14 second pane
15 third pane
16 outer seal
17 inner interpane spaces
17.1 first inner interpane space
17.2 second inner interpane space
20 web
21 edge of the first pane
22 edge of the second pane
23 edge of the web
24 outer interpane spaces
24.1 first outer interpane space
24.2 second outer interpane space
25 lateral surfaces of the web
a width of the web
b height of the web
d wall thickness of the polymeric main body

1. A spacer for insulating glazing units, the spacer comprising:
a polymeric main body comprising a first pane contact surface and
a second pane contact surface running parallel thereto,
a first glazing interior surface,
a second glazing interior surface,
an outer surface,
a first hollow chamber, and
a second hollow chamber,
wherein
a groove to accommodate a pane parallel to the first pane contact surface and the second pane contact surface runs between the first glazing interior surface and the second glazing interior surface,
the first hollow chamber is adjacent the first glazing interior surface and the second hollow chamber is adjacent the second glazing interior surface,
the lateral flanks of the groove are formed by the walls of the first hollow chamber and of the second hollow chamber, and
a gas-permeable insert is contained in the groove or at least two inserts are mounted at a distance of at least 1 mm from one another.

2. The spacer according to claim 1, wherein the insert is made of a material different from a material of the polymeric main body.

3. The spacer according to claim 1, wherein the insert is coextruded with the polymeric main body.

4. The spacer according to claim 1, wherein the insert is slid or inserted into the groove.

5. The spacer according to claim 1, wherein the insert contains a butyl sealant.

6. The spacer according to claim 1, wherein the insert contains a thermoplastic elastomer.

7. The spacer according to claim 1, wherein a gas- and vapor-tight barrier is mounted on the outer surface of the polymeric main body and at least a part of the pane contact surfaces.

8. The spacer according to claim 7, wherein the gas- and vapor-tight barrier is implemented as a barrier film, which includes at least one polymeric layer as well as one metallic layer or one ceramic layer.

9. The spacer according to claim 7, wherein the gas- and vapor-tight barrier is implemented as a coating, which contains aluminum, aluminum oxides, and/or silicon oxides.

10. The spacer according to claim 1, wherein a web is mounted below the groove on the side of the spacer opposite the groove.

11. The spacer according to claim 1, wherein the polymeric main body contains polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

12. An insulating glazing unit comprising:
a first pane,
a second pane,
a third pane,
a first inner interpane space between the first pane and the third pane,
a second inner interpane space between the third pane and the second pane, and
a circumferential spacer according to claim 1, wherein
the first pane contacts the first pane contact surface,
the second pane contacts the second pane contact surface,
the third pane is inserted into the groove of the spacer,
at least one insert is mounted in the groove such that a gas exchange between the two inner interpane spaces is possible.

13. The insulating glazing unit according to claim 12, wherein
the first pane protrudes beyond the first pane contact surface and the second pane protrudes beyond the second pane contact surface and
an outer interpane space delimited by the first pane, the second pane, and the outer surface of the spacer is filled with an outer seal.

14. A method for producing an insulating glazing unit according to claim 12, comprising the steps of:
a) preparing the polymeric main body with insert,
b) inserting the third pane into the groove of the spacer,
c) mounting the first pane on the first pane contact surface of the spacer,
d) mounting the second pane on the second pane contact surface of the spacer, and
e) pressing together the pane arrangement comprising the panes and the spacer.

15. The method according to claim 14, wherein in step a) the polymeric main body is coextruded with the insert.

16. A method of providing the spacer according claim 1 in multiple glazing units as spacers for the units.

17. The spacer according to claim 6, wherein the insert contains a urethane based thermoplastic elastomer.

18. The spacer according to claim 8, wherein the barrier film includes at least two metallic layers and/or ceramic layers, each of which are arranged alternatingly with each of the at least one polymeric layer.

19. The spacer according to claim 9, wherein the coating is applied by physical vapor deposition.

20. The method according to claim 16, wherein the spacer is provided in insulating glazing units.

21. The method according to claim 20, wherein the spacer is provided in triple insulating glazing units.
